(19) United States
(12) Patent Application Publication
(10) Pub. No.: US 2025/0371159 A1
(43) Pub. Date: Dec. 4, 2025

(54) SYSTEM AND METHOD FOR GENERATING ARTIFICIAL INTELLIGENCE BASED VISUALIZATIONS OF COMPUTING DEVICE SECURITY AND STABILITY

(71) Applicant: BANK OF AMERICA CORPORATION, CHARLOTTE, NC (US)

(72) Inventors: Kathleen Rae Hablutzel, Pittsboro, NC (US); Jinna Kim, Charlotte, NC (US); Robert Nyeland Huggins, Charlotte, NC (US); Paul Martin Mattison, Sherrills Ford, NC (US)

(73) Assignee: BANK OF AMERICA CORPORATION, CHARLOTTE, NC (US)

(21) Appl. No.: 18/675,872

(22) Filed: May 28, 2024

(51) Int. Cl. G06F 21/57; G06F 21/56

(52) U.S. Cl. CPC G06F 21/577; G06F 21/561; G06F 2221/034

(57) ABSTRACT

A system is provided for generating artificial intelligence based visualizations of computing device security and stability. In particular, the system may aggregate various types of data and metrics related to the operational performance, security, and stability of the computing devices and applications within an entity's computing environments. Based on the aggregated data, the system may use an artificial intelligence engine to determine whether a particular area, network, application, or device may be vulnerable. Based on analyzing the data, the system may generate one or more visualizations of the data that reflect the current state of the entity's computing environment as a whole. The system may further be configured to transmit notifications to one or more relevant users associated with the applications or devices subject to the vulnerabilities.

TECHNOLOGICAL FIELD

Example embodiments of the present disclosure relate to a system for generating artificial intelligence based visualizations of computing device security and stability.

### BACKGROUND

There is a need for an intelligent, efficient way to visualize aggregated data in an understandable, user-friendly manner.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for generating artificial intelligence based visualizations of computing device security and stability. In particular, the system may aggregate various types of data and metrics related to the operational performance, security, and stability of the computing devices and applications within an entity's computing environments. Based on the aggregated data, the system may use an artificial intelligence engine to determine whether a particular area, network, application, or device may be vulnerable. Based on analyzing the data, the system may generate one or more visualizations of the data that reflect the current state of the entity's computing environment as a whole. The system may further be configured to transmit notifications to one or more relevant users associated with the applications or devices subject to the vulnerabilities. In this way, the system provides an efficient way to analyze and visualize the state of the entire computing environment within an entity's network.

Accordingly, embodiments of the present disclosure provide a system for generating artificial intelligence based visualizations of computing device security and stability, the system comprising: a processing device; a non-transitory storage device containing instructions when executed by the processing device, causes the processing device to perform the steps of: aggregating status data for one or more computing resources within a network environment; analyzing the status data using an AI engine, wherein analyzing the status data comprises categorizing the status data into one or more categories; detecting, based on analyzing the status data, one or more issues associated with the one or more computing resources; determining a severity level of each of the one or more issues associated with the one or more computing resources; generating a visualization of the status data, wherein the visualization comprises the one or more categories, the one or more issues, and the severity level of each of the one or more issues; and generating a remediation plan comprising one or more remediation steps for resolving the one or more issues.

In some embodiments, the status data comprises performance metrics, security metrics, and stability metrics associated with each of the one or more computing resources.

In some embodiments, the performance metrics comprise at least one of processing load, network load, or memory space, wherein the security metrics comprise at least one of anti-malware definition information or known vulnerabilities, and wherein the stability metrics comprise at least one of resource uptime or resource downtime.

In some embodiments, the one or more computing resources comprises at least one application or one computing device.

In some embodiments, categorizing the status data comprises determining at least one sub-category associated with one of the one or more categories.

In some embodiments, the visualization is an interactive visualization presented on a graphical interface of a user device, wherein the interactive visualization comprises one or more interactable segments that, when selected by the user, present additional layers of information within the status data.

In some embodiments, the one or more remediation steps comprise at least one of applying a software update, updating anti-malware definitions, performing network segmentation, and performing a secure wipe of an affected resource.

Embodiments of the present disclosure also provide a computer program product for generating artificial intelligence based visualizations of computing device security and stability, the computer program product comprising a non-transitory computer-readable medium comprising code causing an apparatus to perform the steps of: aggregating status data for one or more computing resources within a network environment; analyzing the status data using an AI engine, wherein analyzing the status data comprises categorizing the status data into one or more categories; detecting, based on analyzing the status data, one or more issues associated with the one or more computing resources; determining a severity level of each of the one or more issues associated with the one or more computing resources; generating a visualization of the status data, wherein the visualization comprises the one or more categories, the one or more issues, and the severity level of each of the one or more issues; and generating a remediation plan comprising one or more remediation steps for resolving the one or more issues.

In some embodiments, the status data comprises performance metrics, security metrics, and stability metrics associated with each of the one or more computing resources.

In some embodiments, the performance metrics comprise at least one of processing load, network load, or memory space, wherein the security metrics comprise at least one of anti-malware definition information or known vulnerabilities, and wherein the stability metrics comprise at least one of resource uptime or resource downtime.

In some embodiments, the one or more computing resources comprises at least one application or one computing device.

In some embodiments, categorizing the status data comprises determining at least one sub-category associated with one of the one or more categories.

In some embodiments, the visualization is an interactive visualization presented on a graphical interface of a user device, wherein the interactive visualization comprises one or more interactable segments that, when selected by the user, present additional layers of information within the status data.

Embodiments of the present disclosure also provide a computer-implemented method for generating artificial intelligence based visualizations of computing device security and stability, the computer-implemented method comprising: aggregating status data for one or more computing resources within a network environment; analyzing the status data using an AI engine, wherein analyzing the status data comprises categorizing the status data into one or more categories; detecting, based on analyzing the status data, one or more issues associated with the one or more computing resources; determining a severity level of each of the one or more issues associated with the one or more computing resources; generating a visualization of the status data, wherein the visualization comprises the one or more categories, the one or more issues, and the severity level of each of the one or more issues; and generating a remediation plan comprising one or more remediation steps for resolving the one or more issues.

In some embodiments, the status data comprises performance metrics, security metrics, and stability metrics associated with each of the one or more computing resources.

In some embodiments, the performance metrics comprise at least one of processing load, network load, or memory space, wherein the security metrics comprise at least one of anti-malware definition information or known vulnerabilities, and wherein the stability metrics comprise at least one of resource uptime or resource downtime.

In some embodiments, the one or more computing resources comprises at least one application or one computing device.

In some embodiments, categorizing the status data comprises determining at least one sub-category associated with one of the one or more categories.

In some embodiments, the visualization is an interactive visualization presented on a graphical interface of a user device, wherein the interactive visualization comprises one or more interactable segments that, when selected by the user, present additional layers of information within the status data.

In some embodiments, the one or more remediation steps comprise at least one of applying a software update, updating anti-malware definitions, performing network segmentation, and performing a secure wipe of an affected resource.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing system for generating artificial intelligence based visualizations of computing device security and stability, in accordance with an embodiment of the disclosure;

FIG. 2 illustrates an exemplary machine learning subsystem architecture, in accordance with an embodiment of the invention; and

FIG. 3 illustrates a method for generating artificial intelligence based visualizations of computing device security and stability, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, unique characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may refer to a tangible or intangible object that may be used, consumed, maintained, acquired, exchanged, and/or the like by a system, entity, or user to accomplish certain objectives. Accordingly, in some embodiments, the resources may include computing resources such as processing power, memory space, network bandwidth, bus speeds, storage space, electricity, and/or the like. In other embodiments, the resources may include objects such as electronic data files or values, authentication keys (e.g., cryptographic keys), document files, funds, digital currencies, and/or the like.

Across an enterprise's network environment, various types of data may be collected regarding a computing device or application's health and/or performance, which may in turn include information regarding potential issues or vulnerabilities within the devices and/or applications. As the network environment becomes increasingly complex, an entity may find it difficult or even unfeasible to represent the gathered data in an accurate, comprehensible way such that the underlying issues or vulnerabilities may be effectively addressed or remediated. Accordingly, there is a need for an efficient, transparent way to collect, analyze, and represent such data.

To address the above concerns among others, the system described herein provides a way to intelligently gather, analyze, and visualize data regarding the health and performance of computing devices and applications within the entity's computing environments. As an overview, the system may gather and aggregate various types of information regarding the statuses of the computing devices and applications within the network environment. Such information may include, for instance, performance related data (e.g., memory headroom, processing power, networking bandwidth, and/or the like), security related data (e.g., anti-malware definition versions, historical instances of compromise, and/or the like), stability related data (e.g., historical instances of downtime or delayed responsiveness, current operating status, and/or the like), organizational data (e.g., data regarding compliance with internal or external rules, such as data privacy rules), and/or the like.

Based on the aggregated data, the system may use an artificial intelligence (“AI”) module or engine to parse, analyze, and interpret the data. In particular, the AI module may be trained using historical data regarding the health, performance, security, and stability of the various applications and devices within the computing environment. Accordingly, the AI module may ingest the aggregated data using a natural language processing (“NLP”) based algorithm to identify concepts and categorize the various types of data such that the data may be formed into logical groups. In this way, the AI module may be able to intelligently recognize and distinguish performance related data (e.g., processing overhead) from other types of data (e.g., data regarding known vulnerabilities). In some embodiments, categorizing the data may include appending one or more data tags to each piece of data, where each of the data tags is associated with a category (e.g., performance, security, stability, and/or the like). Furthermore, the AI engine may append data tags to other data tags to create sub-categories under another category. For instance, the AI engine may append a “memory space” tag to the “performance” tag associated with a piece of data (e.g., information regarding the available memory space of a particular computing device within the entity's network).

Once the aggregated data has been intelligently categorized, the system may generate one or more visualizations of the data according to the identified categorizations. In this regard, the one or more visualizations may be an interactive visualization that may be configured to be interactable with the user. The visualization may be presented to a user, for instance, on a graphical user interface presented to the user (e.g., on a display of a user device). In an exemplary embodiment, the visualization may be a pie chart, where each segment of the pie chart may be a high level category (e.g., “performance,” “security,” and/or the like). Upon receiving an input from the user to select a particular category (e.g., the user clicking the “security” segment of the pie chart), the interactive visualization may call a drill-down function that causes one or more sub-categories associated with the selected category to appear (e.g., “security definitions,” “known vulnerabilities,” and/or the like). In this regard, each of the subcategories may be displayed within or adjacent to the selected segment of the pie chart. In turn, each of the sub-categories may also be interactable such that the user may select the sub-category (e.g., “known vulnerabilities”) to reveal additional sub-categories (e.g., second level sub-categories), where each second level sub-category may include a particular type of known vulnerability (e.g., “DDoS vulnerability”). The second level-sub-category may further be interacted with by the user to reveal one or more third level sub-categories, where each of the one or more third level sub-categories may indicate a particular device and/or application that may be associated with or subject to the selected second level sub-category. In this way, the system may provide an organized, user-friendly visual representation of the data aggregated across the entire computing network. It should be understood that while the foregoing exemplary embodiment contemplates the visualization being a pie chart, various other visualizations are also within the scope of the present disclosure, such as a bar graph, directional node graph, flowchart, tree, and/or the like.

The AI module may then assess the severity of the detected issues associated with each category and/or sub-category. In this regard, the severity of an issue may be determined by the AI module according to historical baseline data regarding the security, performance, and stability of the various resources in the network environment. For instance, relatively small deviations from the historical baseline may be characterized by the AI module as having a relatively low severity, whereas large deviations from the historical baseline may be characterized by the AI module as having a high severity. In some embodiments, the degree of severity of the issue may be color coded on the visualization of the various categories and resources. For instance, the segments of the chart representing relatively low severity issues may be highlighted in yellow, whereas the segments representing relatively high severity issues may be highlighted in red or orange.

In some embodiments, the drill-down functionality may be configured to display the relationships and/or dependencies between the various sub-categories. For instance, a vulnerability or performance issue of one device (e.g., a server) may further cause one or more issues on an application that may depend on the vulnerable or affected device. Accordingly, upon receiving a user input to interact with a particular sub-category (e.g., clicking on or hovering over the relevant segment of the chart), the visualization may be configured to display one or more links (e.g., solid lines, dotted lines, dashed lines, and/or the like) between a first sub-category and a second sub-category. In this way, the system may provide a way to understand the way in which the various platforms, devices, and applications within the network environment are connected and related.

Based on the detected and categorized issues with the various elements of the network environment, the AI module may further be configured to generate a remediation plan to address the detected issues, where the remediation plan may comprise one or more recommended remediation steps for resolving the issues. For instance, the remediation steps may include applying a software update or patch, updating anti-malware definitions, performing secure isolation or wiping of affected devices, modification of code to redirect malfunctioning or faulty dependencies, and/or the like. In this regard, the remediation plan may be transmitted in a notification to one or more users associated with the affected resources (e.g., the development and/or admin team associated with an affected application). In some embodiments, one or more of the remediation steps within the remediation plan may be executed automatically by the system to remediate the detected issues.

In some embodiments, the visualization may incorporate an explainable AI (“XAI”) description associated with one or more sub-categories, resources, or issues. In this regard, the description may include an explanation of the processes and rationale with respect to the decisions made by the AI module (e.g., how the various issues and resources were categorized, how the severity levels were determined, how and/or why certain remediation processes were recommended or executed, and/or the like). Accordingly, upon detecting a user input requesting the explanation of the workings of the AI module (e.g., the user selects or highlights the “description” or “explanation” button associated with a particular segment of the chart), the AI module may present the XAI description on the graphical user interface on which the visualization is presented. In this way, the system may increase the transparency of the processes of the AI module to enhance the understanding of the user of the visualization presented on the graphical interface.

The system as described herein provides a number of technological benefits over conventional methods for data visualization. For instance, by using an AI-based module, the system may be able to effectively represent immense amounts of data aggregated from across an entity's complex network environment. Furthermore, by using an explainable AI framework, the system may enhance the user experience by providing insights into the decisioning of the AI engine.

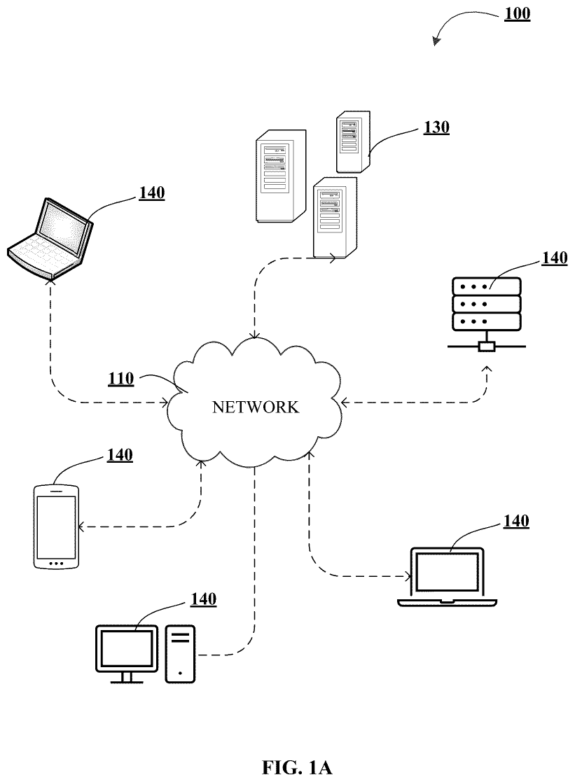

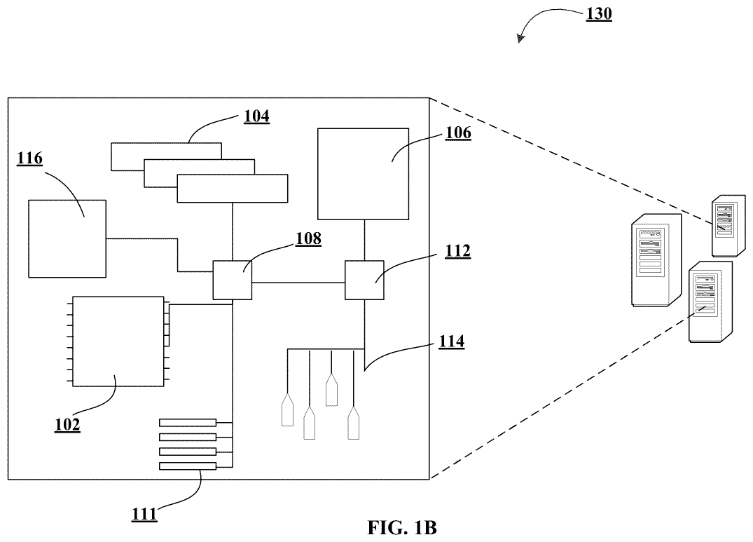

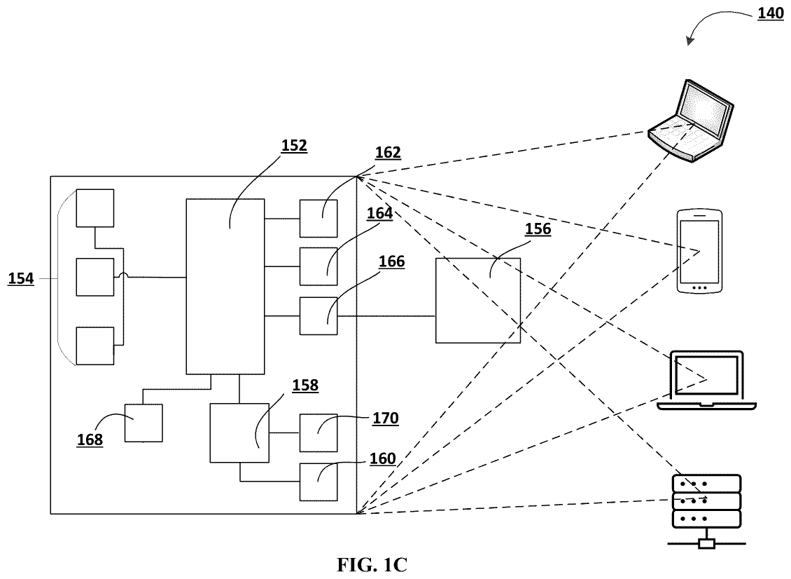

Turning now to the figures, FIGS. 1A-1C illustrate technical components of an exemplary distributed computing environment 100 for the system for generating artificial intelligence based visualizations of computing device security and stability. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. For instance, the functions of the system 130 and the endpoint devices 140 may be performed on the same device (e.g., the endpoint device 140). Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. In some embodiments, the system 130 may provide an application programming interface (“API”) layer for communicating with the end-point device(s) 140.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102 (which may also be referred to herein as a “processing device”), memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

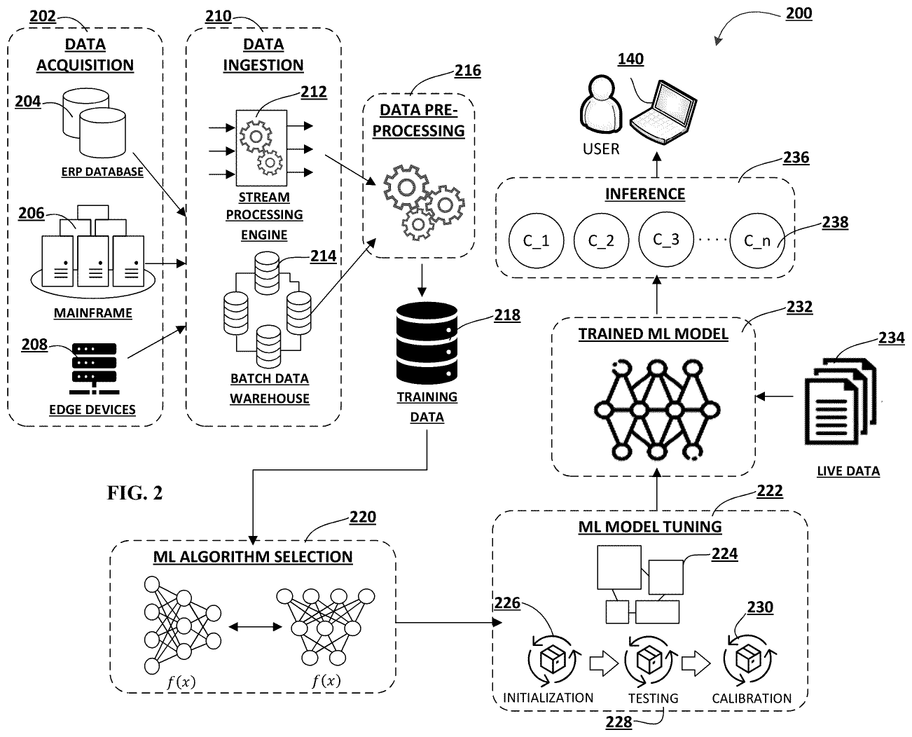

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2. . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2. . . . C_n 238) live data 234 based on how similar they are to one another to solve exploratory challenges where little is known about the data, provide a description or label (e.g., C_1, C_2. . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

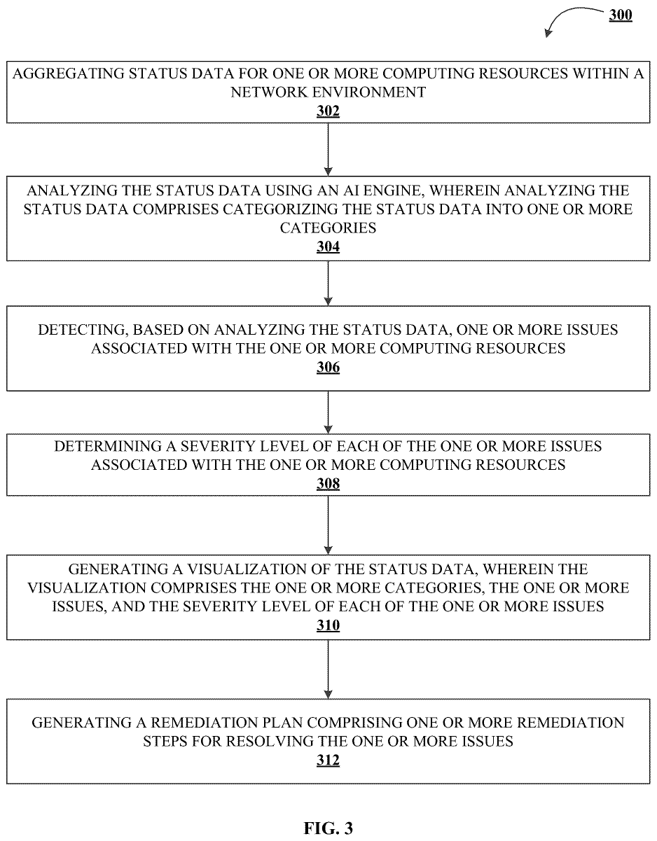

FIG. 3 illustrates a method 300 for generating artificial intelligence based visualizations of computing device security and stability. As shown in block 302, the method includes aggregating status data for one or more computing resources within a network environment. The status data may include various types of information regarding the overall health of the various computing resources within the network environment (e.g., computing devices, applications, subnetworks, and/or the like). Accordingly, the status data may include performance metrics (e.g., processing load, network load, memory space, and/or the like), security metrics (e.g., anti-malware definition information, known vulnerabilities, historical data regarding compromise or intrusions, and/or the like), stability metrics (e.g., resource uptime, resource downtime, historical instances of resource unavailability or access delays, and/or the like).

Next, as shown in block 304, the method includes analyzing the status data using an AI engine, wherein analyzing the status data comprises categorizing the status data into one or more categories. The AI engine may be trained using historical status data regarding the various computing resources. By analyzing the historical status data, the system may establish a “normal” or “baseline” for the various metrics within the status data. Further, the AI engine may read and parse the status data and categorize the status data according to the characteristics identified by the AI engine. For instance, the AI engine may recognize a recorded processing load of a particular server (e.g., 50%) as being associated with the concept of resource performance. Accordingly, the piece of data regarding processing load of the server may be tagged with the “performance metric” category by the AI engine. In some embodiments, the AI engine may append additional tags to each identified categories, where the additional tags may be considered to be “sub-categories” by the system. Tags may further be appended to each sub-categories, allowing for a nesting structure of categorization to the nth level.

Next, as shown in block 306, the method includes detecting, based on analyzing the status data, one or more issues associated with the one or more computing resources. The one or more issues may be related to the various types of metrics analyzed by the AI engine. Accordingly, the one or more issues may include performance issues (e.g., slow processing speeds, operating system hangs, dropped incoming requests due to resource overload, and/or the like), security issues (e.g., vulnerability to certain intrusion vectors, outdated definitions or certificates, unsupported or EOL applications or operating system, and/or the like), stability issues (e.g., system crashes, network disconnects, and/or the like).

Next, as shown in block 308, the method includes determining a severity level of each of the one or more issues associated with the one or more computing resources. Determining the severity level of the detected issues may include comparing the current readings from the status data with the established baselines from the historical data. The degree of departure from the established baselines may be proportional to the determined severity level of the issue. For example, a relatively large delta (e.g., 90% processing load) from the baseline (e.g., 30% processing load) may be assigned a relatively high severity level (e.g., 8 of 10), whereas a relatively low delta (e.g., 40% processing load) from the baseline may be assigned a relatively low severity level (e.g., 3 of 10).

Next, as shown in block 310, the method includes generating a visualization of the status data, wherein the visualization comprises the one or more categories, the one or more issues, and the severity level of each of the one or more issues. The visualization may be, for instance, a pie chart, bar graph, directional node graph, tree, flow diagram, and/or the like that may comprise one or more elements or segments representing the various categories, subcategories, resources, and/or detected issues. The visualization may be presented to the user on a graphical interface, where the elements or segments of the visualization may be interactable. In this regard, when the user selects the interactable elements or segments (e.g., by clicking the segment or hovering over the segment with a user controlled pointer such as a mouse cursor, providing touch inputs on a touch screen, providing a voice input, and/or the like), the interactable element or segments may include a drill-down function that may present additional layers of information associated with the selected element or segment. For example, the user may click on the segment labeled “Performance,” which may cause another segment to appear proximate to the “Performance” segment, where the another segment is labeled with a subcategory associated with the “Performance” category (e.g., “network bandwidth”). The user may then in turn select the another segment to cause one or more additional segments to appear that contain additional layers of information related to the selected subcategory. In some embodiments, the severity level of the detected issues may be reflected in a segment of the visualization corresponding to the detected issue, where the segment may be color-coded according to the severity level (e.g., low to moderate severity levels in shades of yellow, high severity levels in shades of orange or red).

Next, as shown in block 312, the method includes generating a remediation plan comprising one or more remediation steps for resolving the one or more issues. The remediation plan may include steps such as applying a software update, updating anti-malware definitions, performing network segmentation, performing a secure wipe of an affected resource, and/or the like. In some embodiments, a description of the one or more steps of the remediation plan may be displayed within the elements or segments of the visualization selected by the user. For instance, if the user selects the element within the visualization corresponding to a known vulnerability associated with a particular application, the graphical interface may be updated to include information about the remediation steps that may be applied to remedy the issue. In some embodiments, the graphical interface may further include an activatable element that, when activated by the user (e.g., by the user clicking on a button), the system may initiate the remediation steps without additional input from the user. In this way, the system provides an efficient, user-friendly way to visualize system health across the entirety of the entity's network environment in addition to expedient, secure ways to remedy any detected issues.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein. they are used in a generic and descriptive sense only and not for purposes of limitation.

What is claimed is:

1. A system for generating artificial intelligence based visualizations of computing device security and stability, the system comprising:
a processing device;
a non-transitory storage device containing instructions when executed by the processing device, causes the processing device to perform the steps of:
aggregating status data for one or more computing resources within a network environment;
analyzing the status data using an AI engine, wherein analyzing the status data comprises categorizing the status data into one or more categories;
detecting, based on analyzing the status data, one or more issues associated with the one or more computing resources;
determining a severity level of each of the one or more issues associated with the one or more computing resources;
generating a visualization of the status data, wherein the visualization comprises the one or more categories, the one or more issues, and the severity level of each of the one or more issues; and
generating a remediation plan comprising one or more remediation steps for resolving the one or more issues.

2. The system of claim 1, wherein the status data comprises performance metrics, security metrics, and stability metrics associated with each of the one or more computing resources.

3. The system of claim 2, wherein the performance metrics comprise at least one of processing load, network load, or memory space, wherein the security metrics comprise at least one of anti-malware definition information or known vulnerabilities, and wherein the stability metrics comprise at least one of resource uptime or resource downtime.

4. The system of claim 1, wherein the one or more computing resources comprises at least one application or one computing device.

5. The system of claim 1, wherein categorizing the status data comprises determining at least one sub-category associated with one of the one or more categories.

6. The system of claim 1, wherein the visualization is an interactive visualization presented on a graphical interface of a user device, wherein the interactive visualization comprises one or more interactable segments that, when selected by the user, present additional layers of information within the status data.

7. The system of claim 1, wherein the one or more remediation steps comprise at least one of applying a software update, updating anti-malware definitions, performing network segmentation, and performing a secure wipe of an affected resource.

8. A computer program product for generating artificial intelligence based visualizations of computing device security and stability, the computer program product comprising a non-transitory computer-readable medium comprising code causing an apparatus to perform the steps of:
aggregating status data for one or more computing resources within a network environment;
analyzing the status data using an AI engine, wherein analyzing the status data comprises categorizing the status data into one or more categories;
detecting, based on analyzing the status data, one or more issues associated with the one or more computing resources;
determining a severity level of each of the one or more issues associated with the one or more computing resources;
generating a visualization of the status data, wherein the visualization comprises the one or more categories, the one or more issues, and the severity level of each of the one or more issues; and
generating a remediation plan comprising one or more remediation steps for resolving the one or more issues.

9. The computer program product of claim 8, wherein the status data comprises performance metrics, security metrics, and stability metrics associated with each of the one or more computing resources.

10. The computer program product of claim 9, wherein the performance metrics comprise at least one of processing load, network load, or memory space, wherein the security metrics comprise at least one of anti-malware definition information or known vulnerabilities, and wherein the stability metrics comprise at least one of resource uptime or resource downtime.

11. The computer program product of claim 8, wherein the one or more computing resources comprises at least one application or one computing device.

12. The computer program product of claim 8, wherein categorizing the status data comprises determining at least one sub-category associated with one of the one or more categories.

13. The computer program product of claim 8, wherein the visualization is an interactive visualization presented on a graphical interface of a user device, wherein the interactive visualization comprises one or more interactable segments that, when selected by the user, present additional layers of information within the status data.

14. A computer-implemented method for generating artificial intelligence based visualizations of computing device security and stability, the computer-implemented method comprising:
aggregating status data for one or more computing resources within a network environment;
analyzing the status data using an AI engine, wherein analyzing the status data comprises categorizing the status data into one or more categories;
detecting, based on analyzing the status data, one or more issues associated with the one or more computing resources;
determining a severity level of each of the one or more issues associated with the one or more computing resources;
generating a visualization of the status data, wherein the visualization comprises the one or more categories, the one or more issues, and the severity level of each of the one or more issues; and
generating a remediation plan comprising one or more remediation steps for resolving the one or more issues.

15. The computer-implemented method of claim 14, wherein the status data comprises performance metrics, security metrics, and stability metrics associated with each of the one or more computing resources.

16. The computer-implemented method of claim 15, wherein the performance metrics comprise at least one of processing load, network load, or memory space, wherein the security metrics comprise at least one of anti-malware definition information or known vulnerabilities, and wherein the stability metrics comprise at least one of resource uptime or resource downtime.

17. The computer-implemented method of claim 14, wherein the one or more computing resources comprises at least one application or one computing device.

18. The computer-implemented method of claim 14, wherein categorizing the status data comprises determining at least one sub-category associated with one of the one or more categories.

19. The computer-implemented method of claim 14, wherein the visualization is an interactive visualization presented on a graphical interface of a user device, wherein the interactive visualization comprises one or more interactable segments that, when selected by the user, present additional layers of information within the status data.

20. The computer-implemented method of claim 14, wherein the one or more remediation steps comprise at least one of applying a software update, updating anti-malware definitions, performing network segmentation, and performing a secure wipe of an affected resource.
